(19) United States
(12) Patent Application Publication
(10) Pub. No.: US 2010/0215866 A1
(43) Pub. Date: Aug. 26, 2010

(54) Method for coating an electrode on a wafer

(75) Inventors: Chih-Hung Wu, Longtan Shaing (TW); Chih-Kang Chao, Taipei City (TW); Shen-Liu Kenh, Shigang Shiang (TW); Chun-Ling Chang, Longtan Shiang (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/987,402

(22) Filed: Nov. 29, 2007

(51) Int. Cl. B05D 5/12; B05D 3/10

(52) U.S. Cl. 427/534; 427/58

(57) ABSTRACT

There is disclosed a method for coating an electrode on a wafer. Firstly, there is provided a wafer. Secondly, a metal area is defined in an upper surface of the wafer. Thirdly, the metal area is roughened via etching. Finally, an electrode is coated on the metal area via deposition.

### BACKGROUND OF INVENTION

1. Field of Invention

The present invention relates to a method for coating an electrode on a wafer and, more particularly, to a method for coating an electrode on a wafer after roughening the wafer.

2. Related Prior Art

Referring to FIG. 6, there is shown a wafer 31 coated with an electrode 32 according to a conventional method. There is an interface 311 between the wafer 31 and the electrode 32. The epitaxial growth of the metal used for the electrode 32 is conducted on the smooth interface 311. The interface 311 is smooth so that the electrode 32 might be moved on or peeled from the wafer 31. In such a case, the installing of following elements on the wafer 31 via the electrode 32 might be poor. In the worst scenario, the following elements might malfunction. Hence, a resultant product might be defected.

The present invention is therefore intended to obviate or at least alleviate the problems encountered in prior art.

### SUMMARY OF INVENTION

It is the primary objective of the present invention to provide a method for firmly coating an electrode on a wafer.

To achieve the foregoing objective, the method includes the step of providing a wafer, the step of defining a metal area in an upper surface of the wafer, the step of roughening the metal area via etching and the step of coating an electrode on the metal area via deposition.

Other objectives, advantages and features of the present invention will become apparent from the following description referring to the attached drawings.

### BRIEF DESCRIPTION OF DRAWINGS

The present invention will be described via detailed illustration of the two embodiments referring to the drawings.

FIG. 1 is a flowchart of a method for coating an electrode on a wafer according to the preferred embodiment of the present invention.

FIG. 2 is a side view of a wafer provided in the method shown in FIG. 1.

FIG. 3 is a partial top view of the wafer shown in FIG. 2.

FIG. 4 is a side view of the wafer shown in FIG. 2 after a roughening step.

FIG. 5 is a side view of an electrode coated on the wafer shown in FIG. 4.

FIG. 6 is a side view of an electrode coated on a wafer according to a conventional method.

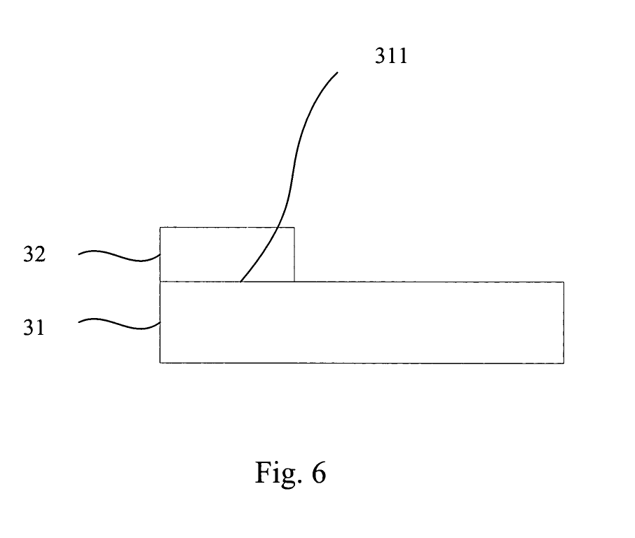

### DETAILED DESCRIPTION OF PREFERRED EMBODIMENT

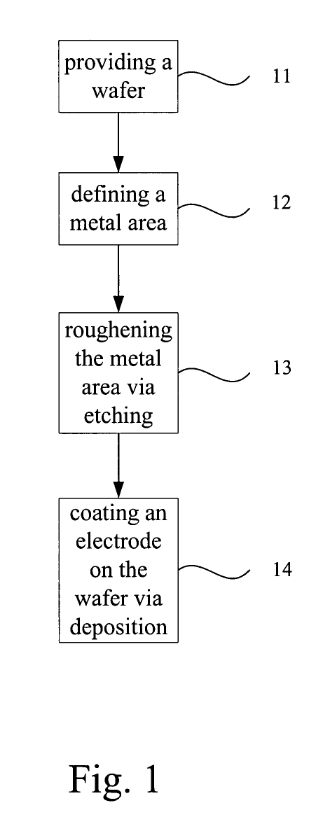

Referring to FIG. 1, there is shown a method for coating an electrode on a wafer according to the preferred embodiment of the present invention.

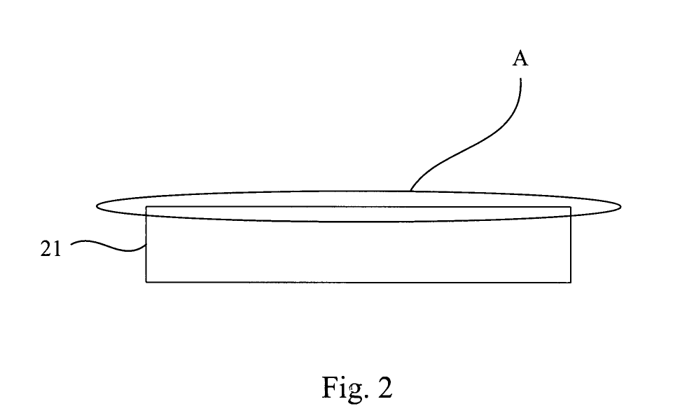

Referring to FIGS. 1 and 2, at 11, a wafer 21 is provided.

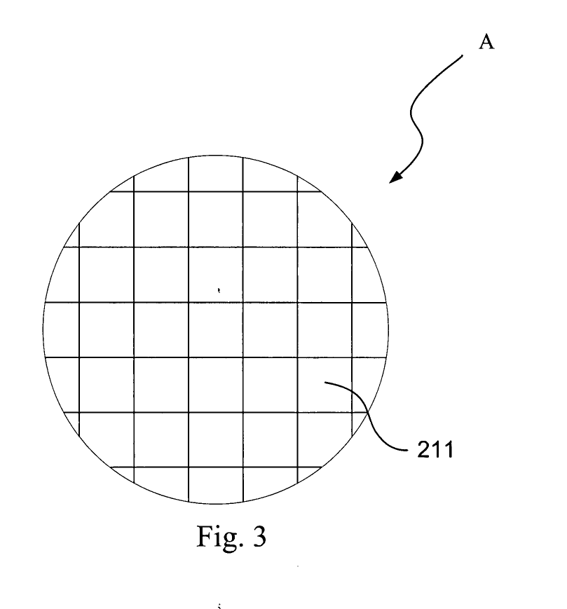

Referring to FIGS. 1 and 3, at 12, a metal area 211 is defined in an upper surface of the wafer 21 with a mask or by impression.

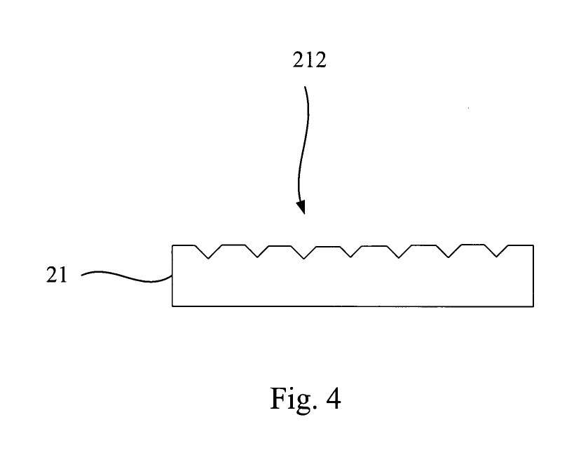

Referring to FIGS. 1 and 4, at 13, the metal area 211 is roughened via etching. After the etching, the metal area 211 is turned into a roughened area 212. The etching may be physical etching, chemical etching, inductively coupled plasma-based etching, dry etching, wet etching or photoelectrochemical wet-etching.

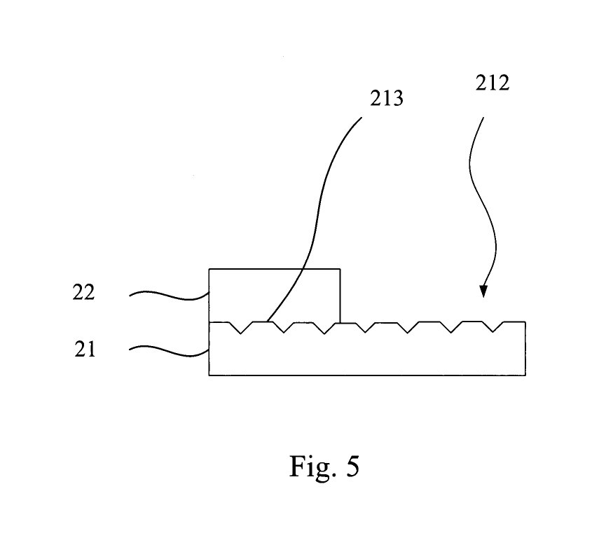

Referring to FIGS. 1 and 5, at 14, the roughened area 212 is coated with an electrode 22 according to a deposition process, thus forming a roughened interface 213 between the electrode 22 and the wafer 21. Therefore, the coating of the electrode 22 on the wafer 21 is firm. The deposition process is an electroplating process, an electro-less plating process or a physical vapor deposition process.

As discussed above, the electrode, the metal area 211 is defined in an upper surface of the wafer 21. Then, the metal area 211 is roughened and turned into a roughened area 212. Finally, an electrode 22 is coated on the roughened area 212. The interface 213 between the electrode 22 and the wafer 21 is roughened. Hence, the coating of the electrode 22 on the wafer 21 is firm.

The method according to the present invention ensures the firm coating of the electrode 22 on the wafer 21. Therefore, the installing of following elements on the wafer 21 via the electrode 22 is firm, and normal functioning of the following elements is ensured.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for coating an electrode on a wafer comprising:
providing a wafer;
defining a metal area in a surface of the wafer;
roughening the metal area via etching;
coating an electrode on the metal area via deposition.

2. The method according to claim 1, wherein the metal area is defined with a mask.

3. The method according to claim 1, wherein the metal area is defined via impression.

4. The method according to claim 1, wherein the etching is selected from a group consisting of physical etching and chemical etching.

5. The method according to claim 4, wherein the etching is selected from a group consisting of inductively coupled plasma-based etching, dry etching, wet etching and photoelectrochemical etching.

6. The method according to claim 1, wherein the deposition is selected from a group consisting of electroplating, electro-less plating and physical vapor deposition.
